(19) United States
(12) Patent Application Publication
(10) Pub. No.: US 2011/0074163 A1
(43) Pub. Date: Mar. 31, 2011

(54) Cangrier-M87 machine or C-M87 a very powerful synchronized multi-lever perpetual motion machine designed for hydroelectric (hydraulic) power generation water recycling concept

(75) Inventor: Edgardo Co Timcang, SR., Las Pinas City (PH)

(73) Assignee: Mary Grace Soriano Timcang, San Diego, CA (US)

(21) Appl. No.: 12/586,975

(22) Filed: Sep. 29, 2009

(51) Int. Cl. F02B 63/04; F03B 17/04

(52) U.S. Cl. 290/1 R; 415/916

(57) ABSTRACT

When water is pumped manually to the overhead tank, the weight of the water is felt on the opposite end of the lever. Thus, an equal or heavier weight to counter that weight is thought of This idea works on the Output Process but not on the Input Process. However, unlike conventional water pumps, C-M87 works on both processes using techniques (invention) that employ the underlying Principles of Equilibrium or Perfect Balance. These techniques constitute the secret of C-M87, a very powerful multi-lever perpetual motion machine capable of using equal or heavier weights to counter the weights on the other end of the lever on both the Input and the Output Operations. Therefore, since it is perfectly balance, pumping out 2 cubic meters of water per stroke through a 1.6-meter diameter 200-meter high pipe, with total water weight of 400 tons, becomes an easy task for C-M87.

### BACKGROUND OF THE INVENTION

My quest for a machine that runs without the need of any fossil fuel, nuclear, or any prime mover that needs consumable materials or elements, started in August 1970 in my Earth Science subject. It started when one of my classmates raised the question on how to control air, water and noise pollution and radiation. Then somebody answered: “Ma'am, through perpetual motion machine!”. Thenceforth, my research and study for that elusive machine has been born and intensified. Time, effort, and money were all focused on how to discover such machine. I have also read and heard about perpetual motion machines run by gravity, spring, flywheel, magnet, electromagnet, but all are bulky and impracticable. I concentrated on known renewable energies as well, but all have limitations and drawbacks. Because of these imperfections, my research and experiment persisted. I continued such endeavor when I worked in Bahrain and Saudi Arabia, and when I was back to the Philippines. Sometime in early 1980s, I became interested in water pumps. I devoted myself on studying it extensively. Then suddenly, in mid 1980's, the first clue came flashing into my mind. If the weight of the water inside the pipe, that is from the tip of the piston all the way up to the tip of the pipe, is counterbalanced by the same weight on the other end of the lever, then pumping out such weight of water (Output Operation) can be made even through the tip of my finger. But how about the water intake (Input Operation) where the piston draws water from the supply source where, in such operation, the valve is closed? The same problem will occur! Only this time, the weight problem is shifted to the counterweight instead of the water weight. How can we solve this problem? This is precisely the reason why C-M87 has been discovered and finally invented.

### BRIEF SUMMARY OF THE INVENTION

In general, the principle and concept of C-M87 is basic of all basics. It adapts the underlying principles of equilibrium where, a lever is used to pump water. However, C-M87, unlike ordinary water pumps, employs Techniques (the invention) that have not been discovered since time immemorial. These techniques made C-M87 the most powerful machine ever invented and the most amazing discovery is that it is a perpetual motion machine! The saying that “I can lift a mountain through the tip of my finger” is no longer an exaggeration but a reality. Pumping out water or any liquid, no matter how heavy, high or deep, can be easily done by C-M87. How? By applying the Techniques and the underlying Principles of Equilibrium on both Operations: the Input Operation and the Output Operation—the secret of C-M87, which will solve the grave and infinite energy requirements of mankind through hydroelectric power generation water recycling concept here on earth (and, in the immediate future, C-M3 Version 2, the compact design of C-M87, which can replace the fossil fuel feed prime movers and can be used in outer space).

C-M87 is by far incomparable to known conventional prime movers. C-M87, unlike fossil fuel fed engines and nuclear power plant, does not pollute air and water. It does not produce sound, heat, smoke, waste, and radiation; it does not contribute to air, water and noise pollution, and global warming; it does not cause fire or explosion since it uses water, therefore, it is 100% safe to mankind. Compared to known renewable energies such as hydro, geothermal, solar, wind, sea wave, and sea current, all of which have drawbacks from their power sources, C-M87 does not have any from its power source—gravity. Gravity is consistent. Moreover, compared to all conventional prime movers having the same electric power capacity, it is 40% to 60% cheaper both in short and long term operations. It is 6 to 7 times faster to build comparatively against hydroelectric when it comes to power generation. Since it is a low RPM machine and has relatively few moving parts, it can even last for a century without breakdown. Therefore, blackouts and brownouts can be avoided. Because C-M87 is a noise-free machine, it can be built within a city or urban area. Due to this, expensive pylons, transmission lines and equipment can be minimized or eliminated.

### BRIEF DESCRIPTION OF THE SEVERAL VIEWS OF DRAWINGS

To preclude obstruction of the view of the C-M87 machine's parts specifically the vital parts, and moreover, to visualize clearly the operation and the workability of C-M87, the frame, platform, and foundation are not drawn and some parts are rearranged but do not affect the efficiency of the overall performance of C-M87. Actually the drawings expound only on how C-M87 works using the Techniques and the Principles of Equilibrium and not on how the discharged water drives the Turbine 7C. Using C-M87 in Hydroelectric Power Generation is just among its many uses. Regardless of the height of the Output Pipe 10A, the same (drawing) structure can be used in irrigation, water supply, cooling system, conveyor, elevator, cable car, and many more.

### A) C-M87 The Machine in Perspective

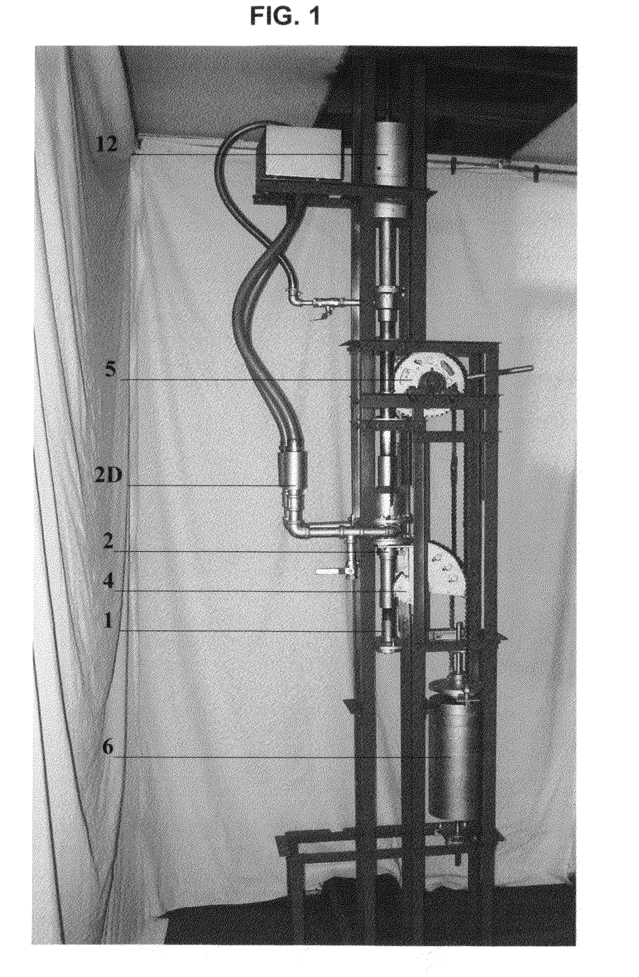

FIG. 1 The Picture of C-M87—the picture depicts the prototype of C-M87. The model is capable of pumping out 70 cc of water per stroke to a height of 1,500 feet using a 1 inch pipe with an estimated water weight of 240 kilos, yet a five year old boy can simply operate it. Since the height is impractical for demonstration, C-M87 is converted into hydraulic form using hydraulic fluid and steel weights instead of water. Please note that on the top of the machine is a solid-steel. This steel weighs 40 kilos representing the weight of the water inside a 254-foot, 2.6-centimeter diameter pipe.

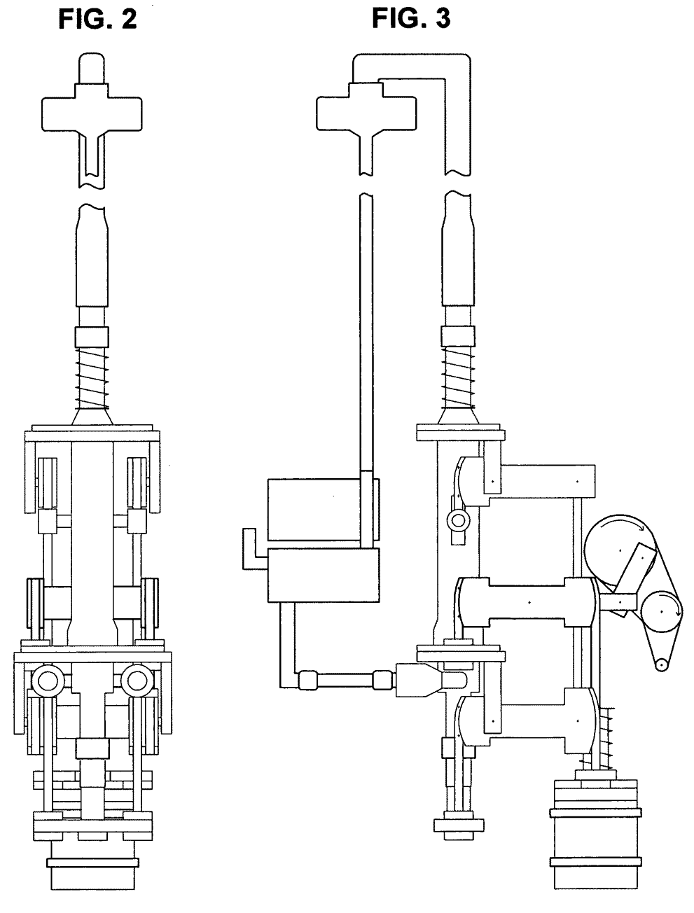

FIG. 2 The Front View of C-M87—depicts the Front View of the non-labeled parts of C-M87.

FIG. 3 The Left Side View of C-M87—depicts the Left Side View of the non-labeled parts of C-M87.

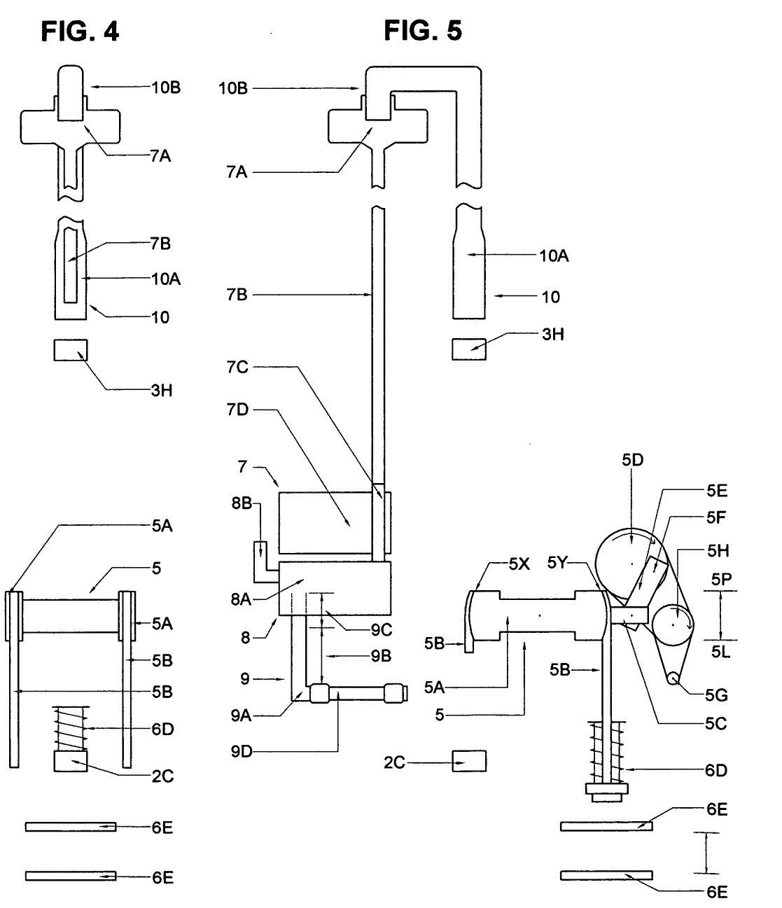

FIG. 4 The Front View of the Non-Moving Component A with Part Number—depicts all labeled parts of the Non-Moving Component A of the machine that are not clearly shown in the Left Side View position.

FIG. 5 The Left Side View of the Non-Moving Component A with Part Number—depicts all labeled parts of the Non-Moving Component A of the machine in a left side view position and shows clearly the Machine/Water Weight Lever Assembly 5, Electric Generating Assembly 7, Storage/Supply Tank Assembly 8, Intake Assembly 9 and Output Pipe Assembly 10.

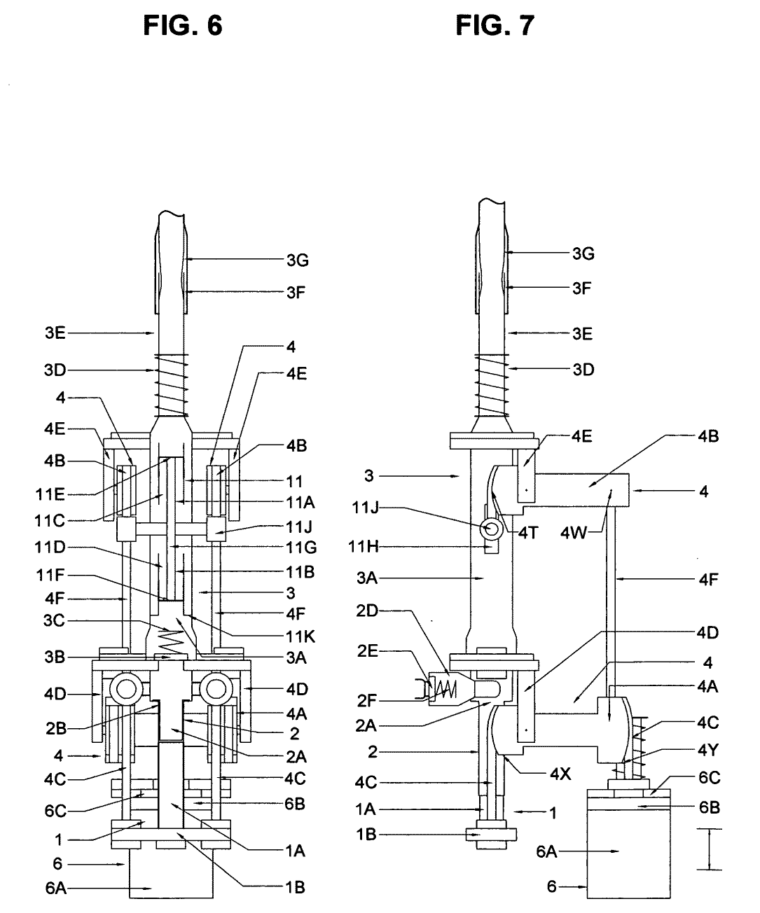

FIG. 6 The Front View of the Moving Component B with Part Number—depicts all labeled parts of the Moving Component B of the machine that are not clearly shown in the Left Side View position.

FIG. 7 The Left Side View of the Moving Component B with Part Number—depicts all labeled parts of the Moving Component B of the machine in a left side view position and shows clearly the Piston Assembly 1, Cylinder/Storage Assembly 2, Output/Discharge Assembly 3 and the Counterweight Assembly 6.

### B) C-M87 During the Output Operation

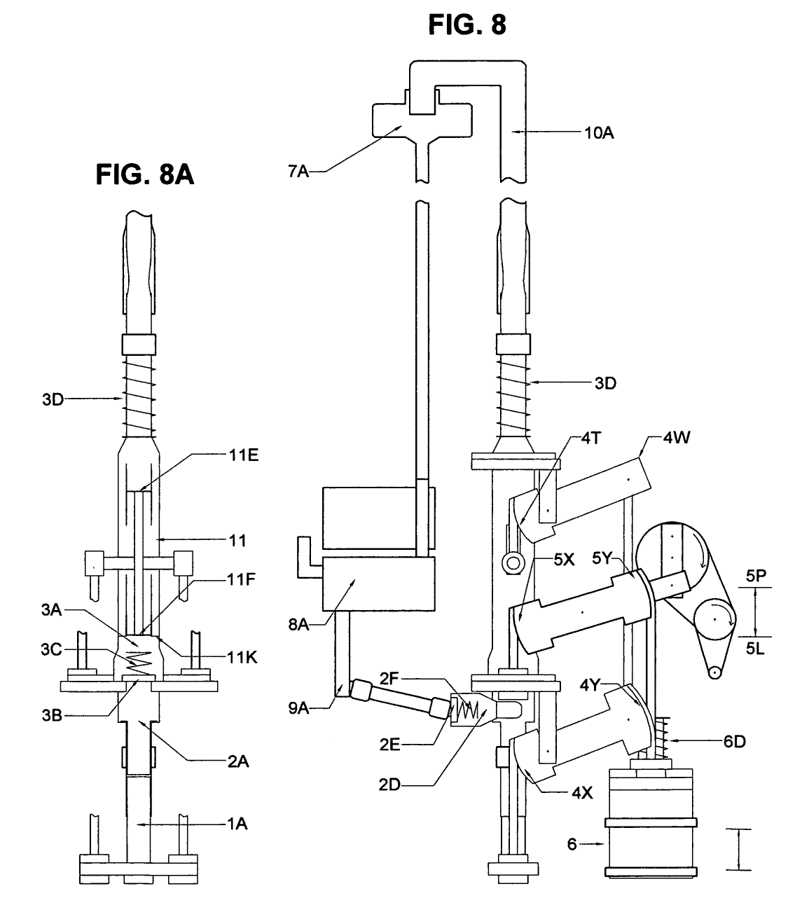

FIG. 8 The Start Position of Output/Discharge Process (or End Position of Input Operation)—depicts the starting position of C-M87 in the Output Operation.

FIG. 8A The Output/Discharge Chamber Cutaway—depicts the Output/Discharge Chamber 3A at the start of the Output/Discharge Process.

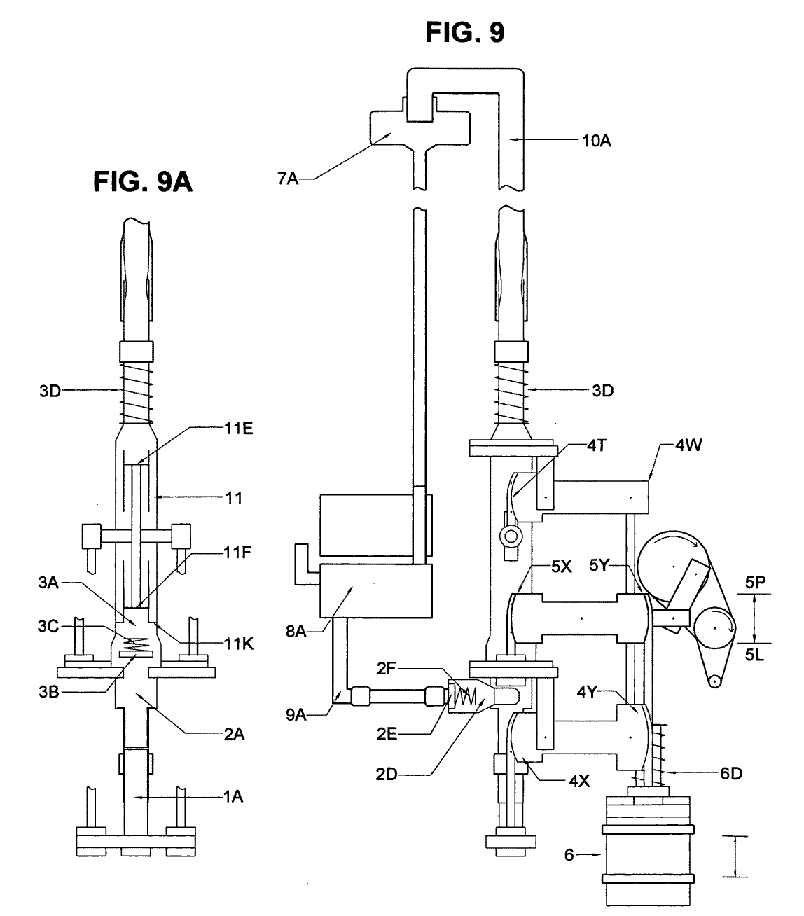

FIG. 9 The Output/Discharge Process—depicts how C-M87 works during the Output Operation especially the movement of the Moving Component B, Machine/Water Weight Lever Assembly 5, Counter Weight Assembly 6; and Valves and Springs.

FIG. 9A The Output/Discharge Chamber Cutaway—depicts the Output/Discharge Chamber during the Output/Discharge Process.

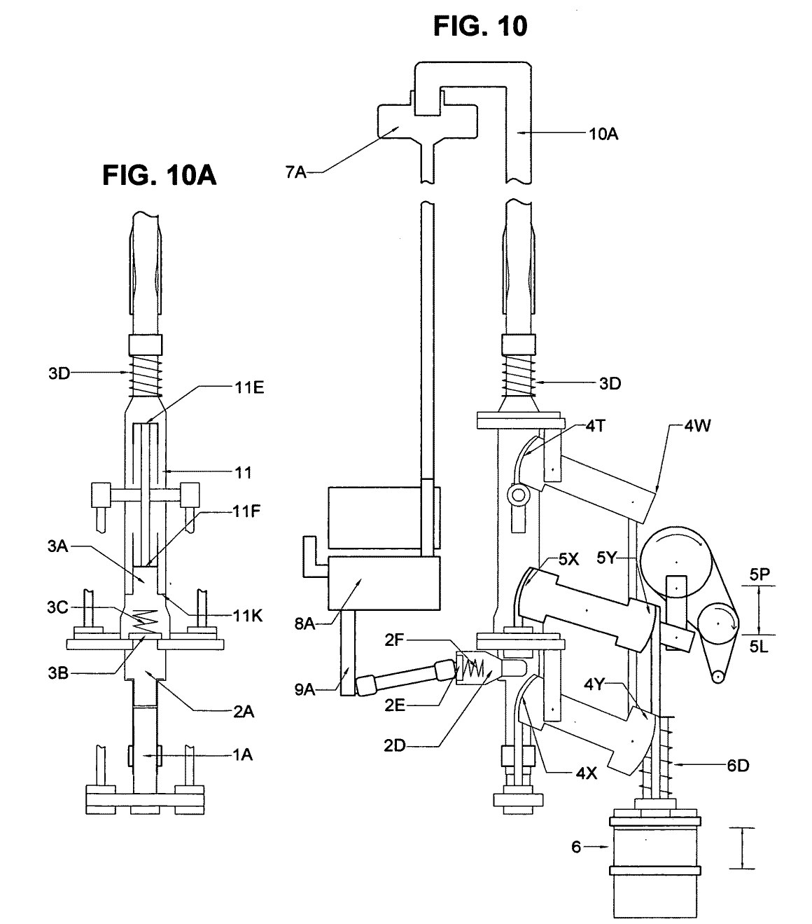

FIG. 10 The End Position of Output/Discharge Process (or Start Position of Input Operation)—depicts the ending position of C-M87 in the Output Operation.

FIG. 10A The Output/Discharge Chamber Cutaway—depicts the Output/Discharge Chamber at the end of the Output Operation.

### C) C-M87 During the Input Operation

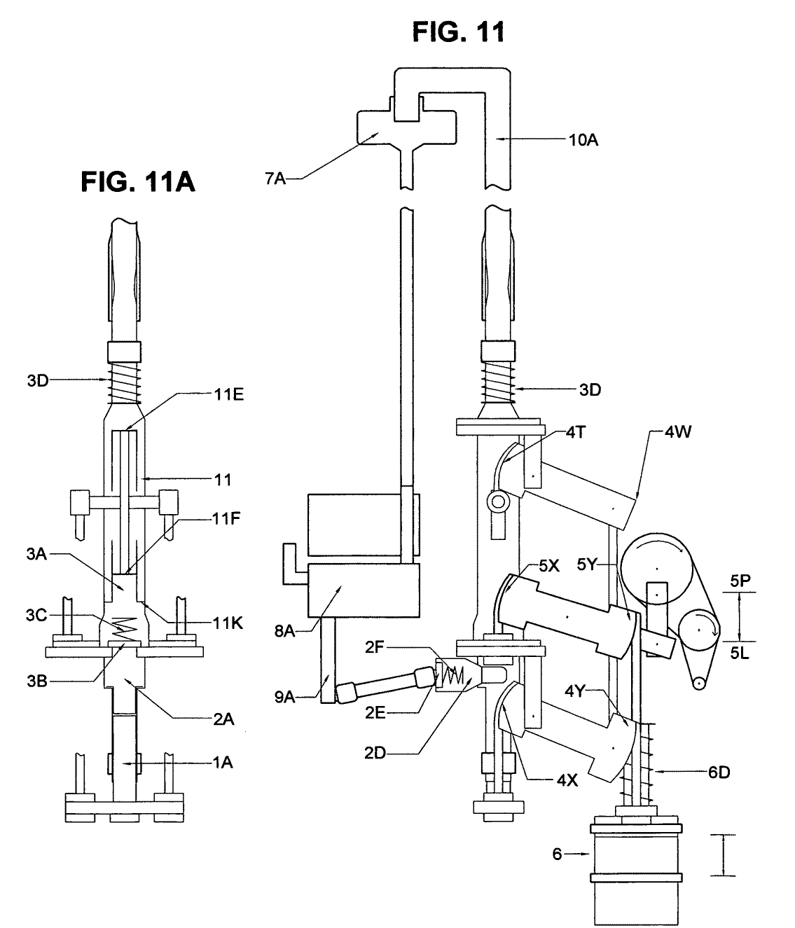

FIG. 11 The Start Position of Input/Intake Process (or End Position of Output Operation)—depicts the starting position of C-M87 in the Input Operation.

FIG. 11A The Output/Discharge Chamber Cutaway—depicts the Output/Discharge Chamber at the start of the Input/Discharge Process.

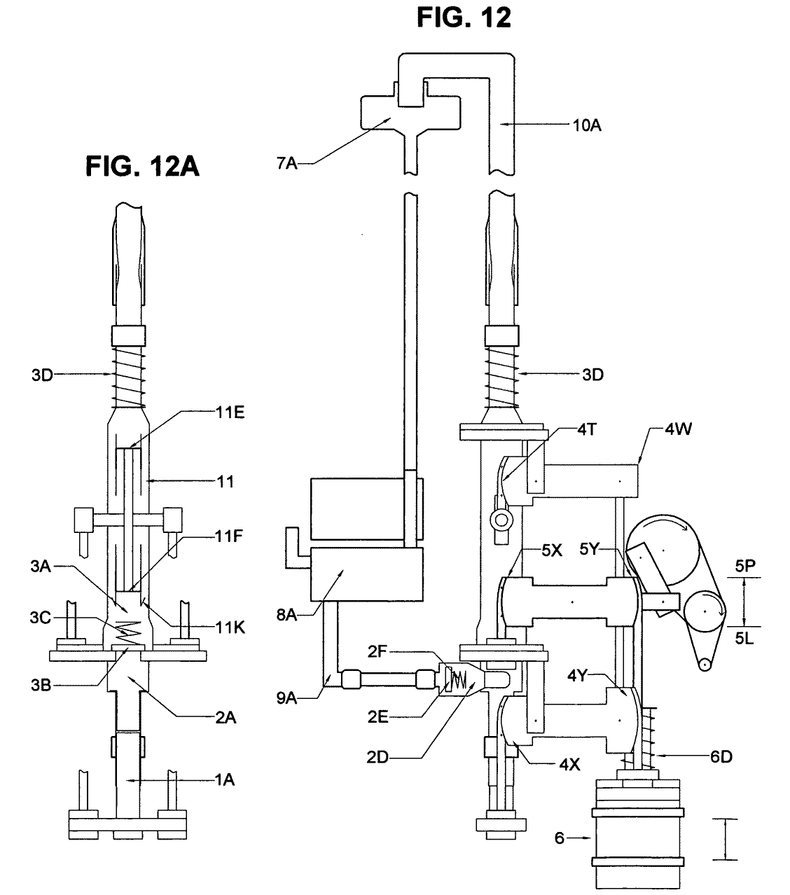

FIG. 12 The Input/Intake Process—depicts how C-M87 works during the Input Operation especially the movements of the Moving Component B, Machine/Water Weight Lever Assembly 5, Counter Weight Assembly 6; and Valves and Springs.

FIG. 12A The Output/Discharge Chamber Cutaway—depicts the Output/Discharge Chamber during the Input/Discharge Process.

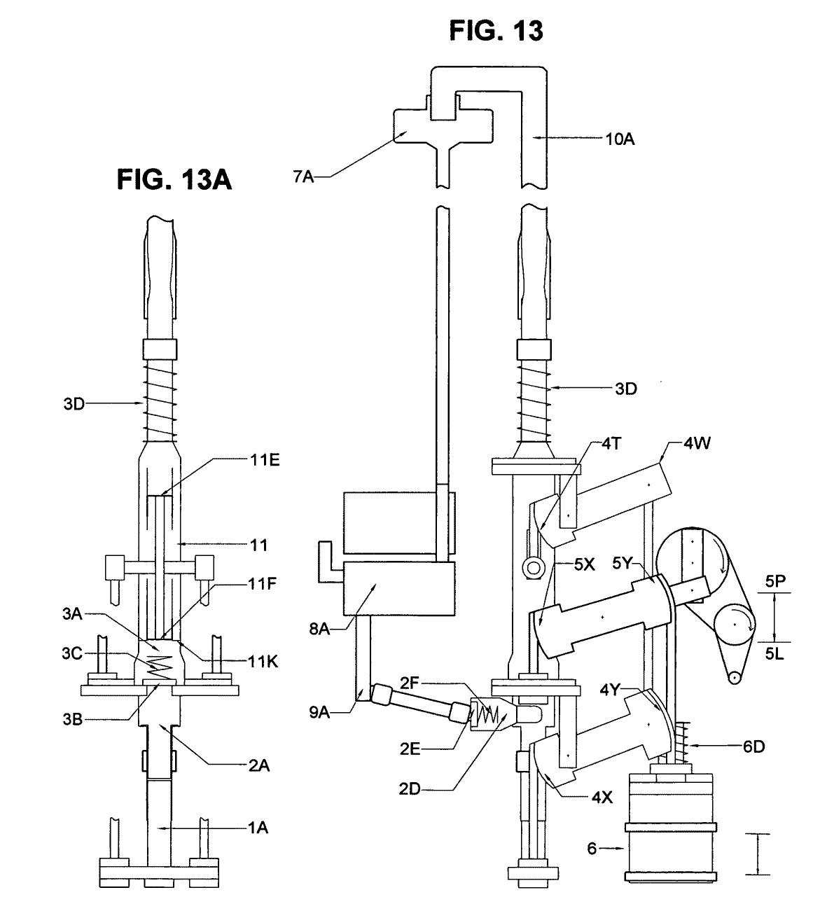

FIG. 13 The End Position of Input/Intake Process (or the Start Position of the Output Operation)—depicts the ending position of C-M87 in the Input Operation.

FIG. 13A The Output/Discharge Chamber Cutaway—depicts the Output/Discharge Chamber at the end of the Input Operation.

### D) Other Drawings

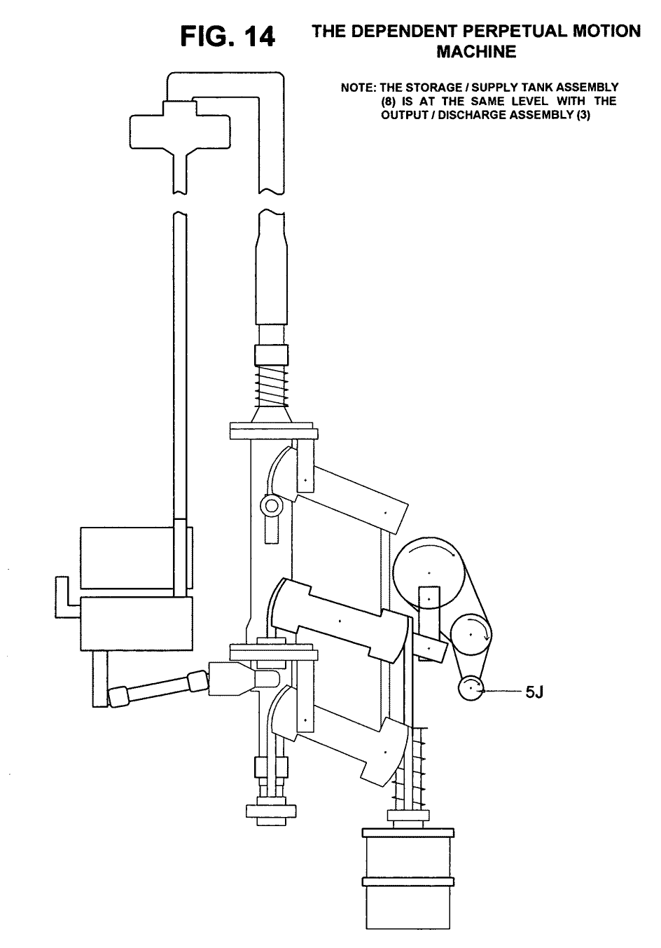

FIG. 14 The Left Side View of C-M87's Dependent Perpetual Motion Machine—depicts every part of C-M87 in a left side view elevation. The drawing points out the main difference between the two perpetual motion machines. These are the Resistance Weight 6B and Pull Weight 6C, Intake's Weight Compensator 9B and the Intake's Outbalancing Weight 9C, which are applicable only to the Absolute.

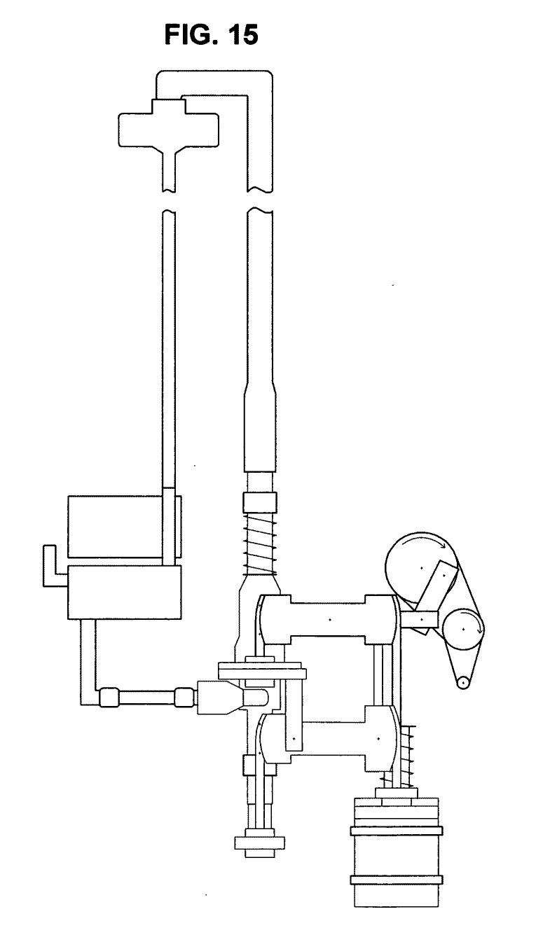

FIG. 15 The C-M87 Drawing Without G-Force Emulator—the drawing depicts the picture of C-M87 without the services of the G-Force Emulator. This C-M87 version is the Synchronized Dual-Lever Perpetual Motion Machine. See Executed Oath.

### DETAILED DESCRIPTION OF THE INVENTION

In all honesty, C-M87's technical aspect is simple. In fact, in my actual explanation and demonstration to my selected kin on how C-M87 works, I needed only 5 minutes. C-M87 is a machine which is basic of all basics. It works primarily on the Techniques and the underlying Principle of Equilibrium. But how does C-M87 handle the Input and Output Operations, the known problem since man has existed? C-M87 has employed simple techniques that have not been discovered since time immemorial. These techniques are fully described and consolidated in the illustration of C-M87 Embodiments.

### A) C-M87 Parts

### B) C-M87 Components

### C) C-M87 Types of Perpetual Motion Machine

### D) C-M87 Operation Defined and Described

### E) C-M87 Choice of Presentation

### F) C-M87 Housekeeping

### G) C-M87 Embodiments

A) C-M87 Parts—C-M87 is divided into 12 major parts (including water) and 58 subparts:
   1 Piston Assembly
      1A Piston—draws water from the Storage/Supply Tank 8A down to the Cylinder/Storage Chamber 2A during the Input Operation, and discharges it to the Output/Discharge Chamber 3A during the Output Operation.
      1B Piston Base—it is the base of the Piston 1A where the Lever 1A 4A is attached by means of the Cable/Chain 4B of the Water Weight Lever Assembly 4.
   2 Cylinder/Storage Assembly
      2A Cylinder/Storage Chamber—stores water drawn by the Piston 1A from the Storage/Supply Tank 8A down to the Intake Pipe 9A during the Input Operation and releases it to the Output/Discharge Chamber 3A during the Output Operation.
      2B Cylinder/Storage Pouch—prevents water from sipping or sneaking between the Piston 1A and the Cylinder/Storage Chamber 2A.
      2C Cylinder/Storage Guide—guides the up and down movements of Cylinder/Storage Assembly 2.
      2D Gate Chamber—receives water from Intake Hydraulic Hose/Pipe Feeder 9D during the Input Operation.
      2E Gate Valve—opens during the Input Operation and closes during the Output Operation.
      2F Gate Valve Spring—a low-tensioned spring designed to push lightly the Gate Valve 2E thus, allows the Gate Valve 2E to open and close easily during the Input and the Output Operations, respectively.
   3 Output/Discharge Assembly
      3A Output/Discharge Chamber—receives water that is being pumped out from Cylinder/Storage Chamber 2A and passes it on to the Output Pipe 10A during the Output Operation.
      3B Discharge Valve—closes during the Input Operation and opens during the Output Operation.
      3C Discharge Valve Spring—a low-tensioned spring designed to push lightly the Discharge Valve 3B thus, allows the Discharge Valve 3B to open and close easily during the Output and the Input Operations, respectively.
      3D Moving Component Momentum Spring—a calibrated spring designed enough to counter the momentum of the Counterweight Assembly 6 and Moving Component B during the Output Operation and to push the Moving Component B at the start of the Input Operation.
      3E Output/Discharge Sliding Piston—guides the up and down movements of the Output/Discharge Assembly 3 through the Output/Discharge Sliding Cylinder 3F.
      3F Output/Discharge Sliding Cylinder—guides the movement of the Output/Discharge Assembly 3 by means of the Output/Discharge Sliding Piston 3E.
      3G Output/Discharge Pouch—prevents water from sipping or sneaking between the Output/Discharge Sliding Piston 3F and the Output/Discharge Sliding Cylinder 3F.
      3H Output/Discharge Guide—guides the up and down movements of Output/Discharge Assembly 3.
   4 Water Weight Lever Assembly
      4A Lever 1A—holds the Piston 1A of the Moving Component B on the End 4X while the Counterweight Assembly 6 on the End 4Y by the Chain/Cable 4B connections. It is in itself perfectly balanced.
      4B Lever 1B—holds the G-Force Emulator Assembly 11 inside the Output/Discharge Chamber 3A by the End 4T while the End 4Y by the End 4W.
      4C Chain/Cable—connects the Lever 1A 4A to the Piston Base 1B of the Moving Component B on the End 4X and the Counterweight Assembly 6 on the End 4Y.
      4D Lever 1A Base Bracket—attached to the flange of the Cylinder/Storage Assembly 3 which holds the Lever 1A 4A.
      4E Lever 1B Base Bracket—attached to the flange of the Cylinder/Storage Assembly 3 which holds the Lever 1B 4B.
      4F Lever 1 Connecting Rod—connects the End 4Y to End 4W.
      4T End—the tip or end of the Lever 1B 4B where the G-Force Emulator is attached.
      4W End—the tip or end of the Lever 1B 4B where the End 4Y is connected.
      4S End—the tip or end of the Lever 1A 4A where the Piston Assembly 1 of the Moving Component B is attached by means of the Chain/Cable 4B.
      4Y End—the tip or end of the Lever 1A 4A where the End 5Y and the whole Counterweight Assembly 6 are attached by means of the Chain/Cable 5B and the Chain/Cable 4B respectively.
   5 Machine/Water Weight Lever Assembly
      5A Lever 2—connects the Cylinder/Storage Assembly 2 and the Output/Discharge Assembly 3 of the Moving Component B on the End 5X while the Counterweight Assembly 6 on the End 5Y by the Chain/Cable 5B. It is in itself perfectly balanced.
      5B Chain/Cable—Connects the End 5X to the Moving Component B and the End 5Y on the End 4Y. A rod can be used to connect the End 5Y to the End 4Y.
      5C Lever 2 Handle—attaches the Lever 2 5A to the Connecting Rod 5E.
      5D Fly Wheel—stabilizes the revolution or speed of the C-M87.
      5E Connecting Rod—connects the Crank Shaft 5F and the Lever 2 Handle 5C.
      5F Crank Shaft—drives the Lever 2 Handle 5C, in up and down motions, by means of the Connecting Rod 5E.
      5G Electric Motor RS—a low-speed a/c motor designed to control the revolution or speed of the C-M87 and not as a prime mover.
      5H Intermediate Pulley and Belts—link the Electric Motor RS 5G and Fly Wheel 5D.
      5J Electric Motor PM (Applicable only to Dependent Perpetual Motion Machine)—drives the Crank Shaft 5F and serves as C-M87's prime mover.
      5L Low Point—the lowest point of travel of the Lever 2 Handle 5C in a downward direction.
      5P High Point—the highest point of travel of the Lever 2 Handle 5C in an upward direction.
      5X End—the tip or end of the Lever 2 5A where the whole Moving Component B is attached by means of the Chain/Cable 5B.
      5Y End—the tip or end of the Lever 2 5A where the End 4Y is attached by means of the Chain/Cable 5B.
   6 Counterweight Assembly
      6A Balancing Weight—equalizes the total weight of the Moving Component B and the water inside the system starting from the tip of the Piston 1A all the way to the tip of the Output Pipe 10A.
      6B Resistance Weight—the weight needed to overcome the resistance.
      6C Pull Weight—the weight needed to pull the Lever 2 5A through the End 5Y in a downward direction so as to perform the Output Operation. The weight of the Pull Weight 6C is calculated based on the speed (cycle per minute) requirements of C-M87. Therefore, the heavier the Pull Weight 6C is, the faster the Output Operation can be. These Resistance Weight 6B and Pull Weight 6C parts of the Counterweight Assembly 6 are counterbalanced by Intake Weight Compensator 9B and are applicable only to Absolute Perpetual Motion Machine.
      6D Counterweight Momentum Spring—a calibrated spring designed enough to counter the momentum of the Counterweight Assembly 6 and the Moving Component B during the Input Operation and to push the Counterweight Assembly 6 at the start of the Output Operation.
      6E Counterweight Guides—guide the up and down movements of the Counterweight Assembly 6.
   7 Electric Generating Assembly
      7A Turbine Reservoir—a shallow reservoir designed to control and maintain water level/pressure and also to ensure air ventilation and to prevent water spillage while receiving water from the Output Pipe Feeder 10B.
      7B Turbine Pipe—receives water coming from the Turbine Reservoir 7A which is used to drive the Turbine 7C.
      7C Turbine—receives water from the Turbine Pipe 7B, which makes the Turbine 7C turn and drive the Electric Generator 7D, then releases the water into the Storage/Supply Tank 8A.
      7D Electric Generator—produces electricity.
   8 Storage/Supply Tank Assembly
      8A Storage/Supply Tank—receives and stores water coming from the Turbine 7C and releases it into the Intake Pipe 9A during the Input Operation.
      8B Storage/Supply Tank Vent—provides air ventilation during the receiving of water from the Turbine 7C and the supplying of water to the Intake Pipe 9A.
   9 Intake Assembly
      9A Intake Pipe—receives water from the Storage/Supply Tank 8A and delivers it to the Gate Chamber 2D during the Input Operation.
      9B Intake's Weight Compensator—the weight of water that is used to compensate the Resistance Weight 6B and the Pull Weight 6C of the Counterweight Assembly 6.
      9C Intake's Outbalancing Weight—the weight needed to outweigh the whole Counterweight Assembly 6 and the weight needed to perform the Input Operation with the same speed (cycle per minute) as of that of the Output Operation. This portion of the Intake Assembly 9 is required only in the Absolute Perpetual Motion Machine.
      9D Intake Hydraulic Hose/Pipe Feeder—a flexible conduit that feeds water coming from the Intake Pipe 9A into the Gate Chamber 2D. It moves along with the Cylinder/Storage Assembly 2 during the Input and Output Operations.
   10 Output Pipe Assembly
      10A Output Pipe—receives water from the Output/Discharge Chamber 3A during the Output Operation and dispatches it to the Output Pipe Feeder 10B.
      10B Output Pipe Feeder—the “U” shape pipe that feeds the discharged water into the Turbine Reservoir 7A.
   11 G-Force Emulator Assembly (Optional)
      Note: G-Force Emulator has a U.S. patent application Ser. No. 12/288,988.
      11A G-Force Emulator 1—its main function is to help lighten up the heavy job of Piston 1A by discharging water into the Output Pipe 10A during the Output Operation.
      11B G-Force Emulator 2—its main function is to help lighten up the heavy job of Piston 1A by accommodating water into the G-Force Emulator 2 Cubicle 11D during the Output Operation.
      11C G-Force Emulator 1 Cubicle—G-Force Emulator 1 11A's housing and cylinder.
      11D G-Force Emulator 2 Cubicle—G-Force Emulator 2 11B's housing and cylinder.
      11E G-Force Emulator 1 Piston—helps the Piston 1A by its discharging job during the Output Operation and pushes down the G-Force Emulator Piston 11F during the Input Operation.
      11F G-Force Emulator 2 Piston—accommodates the water being discharge by the Piston 1A during the Output Operation and displaces it during the Input Operation.
      11G Connecting Rod—connects the G-Force Emulator 1 Piston 11E and the G-Force Emulator 2 Piston 11F.
      11H Air Vent/Slot—allows the synchronized up and down movements of the G-Force Emulator 1 Piston 11E and the G-Force Emulator 2 Piston 11F inside the G-Force Emulator Assembly 11.
      11J Push/Pull Shaft—a vertical shaft which is attached to the Lever 1B Base Bracket 4E. Dependent on Lever 1B 4B, it pushes downward and pulls upward the G-Force Emulator Assembly 11 during the Input Operation and the Output Operation respectively.
      11K G-Force Emulator Valve—opens during the Input Operation and closes during the Output Operation.
      12 Water (or any non-toxic, non-flammable, low viscose liquid or fluid)
B) C-M87 Components—C-M87 is classified into 3 Major Components. They will simplify the understanding on how the machine works. These classifications, which are the Techniques of the Invention, constitute the objects of the Claims Section of the Specification. Without these Components combination, C-M87 will not run.
   A Non-moving Component (represented by bold line)—this classification is composed of 5 Major Non-moving Parts. Although the Lever 2 5A, Connecting Rod 5E and Crank Shaft 5F move in up and down motions, the whole Machine/Water Weight Lever Assembly 5 and the Electric Motor RS 5G or Electric Motor PM 5J (applicable only to Dependent Perpetual Motion Machine) do not move. They are fixed on their bases and are not subject to counterweights of the Counterweight Assembly 6.

| Assembly/Part No. | Description |
|---|---|
| 5 | Machine/Water Weight Lever Assembly |
| 7 | Electric Generating Assembly |
| 8 | Storage/Supply Tank Assembly |
| 9 | Intake Assembly |
| 10 | Output Pipe Assembly |

B Moving Component (represented by thin line)—this classification is composed of 6 Major Moving Parts that move in up and down motions dependent on the End 5X travel during the Input and Output Operations. This Component is the object of the Balancing Weight 6A of the Counterweight Assembly 6. The weight of the Moving Component B and the water inside the system (that is from the tip of the Piston 1A all the way to the tip of the Output Pipe 10A) is equal to the weight of Balancing Weight 6A.

| Assembly/Part No. | Description |
|---|---|
| 1 | Piston Assembly |
| 2 | Cylinder/Storage Assembly |
| 3 | Output/Discharge Assembly |
| 4 | Water Weight Lever Assembly |
| 11 | G-Force Emulator Assembly |

* Water (is not a Machine Part but included in the weight)

C Counterweight Assembly Component—this classification is composed of 1 Major Moving Part. Its function is to equalize the total weight of the Moving Component B and the water inside the system that is, from the tip of the Piston 1A all the way to the tip of the Output Pipe 10A; to provide weight to the Resistance Weight 6B that will overcome the resistance; and finally, to provide the weight needed by the Pull Weight 6C to perform the Output Operation.

| Assembly/Part No. | Description |
|---|---|
| 6 | Counterweight Assembly |

C) C-M87 Types of Perpetual Motion Machine
   1 Absolute Perpetual Motion Machine—we at CIT define it as a perpetual motion machine that runs without the need or aid of a prime mover—the electric motor.
   Outbalancing/Outweighing Approach—The process of outweighing the Moving Component B by the Counterweight Assembly 6 during the Output Operation and outweighing the Counterweight Assembly 6 by the Moving Component B with the aid of the weight of the water coming from the Intake's Outbalancing Weight 9C all the way down to the tip of the Piston 1A during the Input Operation. In this approach, the water level of the Intake's Weight Compensator 9B and Intake's Outbalancing Weight 9C must be higher than the Output/Discharge Chamber 3A whereas the End 5X and Moving Component B are at the highest point of travel. The weight of that height difference is computed: first, to outweigh the Counterweight Assembly 6 and second, to push down the Moving Component B through the Piston 1A having the same speed (cycle per minute) with Pull Weight 6C during the Output Operation. This approach has led to the discovery of the so called Absolute Perpetual Motion Machine.
   2 Dependent Perpetual Motion Machine—we at CIT define it as a perpetual motion machine that runs with the need or aid of a prime mover—the electric motor.
   Perfect Balance Approach—C-M87 works basically on the principle of equilibrium. In this approach, the weight of the Moving Component B and the Counterweight Assembly 6 as a whole are the same; the height of the Storage/Supply Tank 8A is at level with Output/Discharge Chamber 3A's base where the End 5X and the Moving Component B are at the highest point of travel. Also in this approach, the weights of the Resistance Weight 6B and the Pull Weight 6C and the Intake's Outbalancing Weight 9C and the Intake's Weight Compensator 9B are not employed. This resulted to the discovery of the so called Dependent Perpetual Motion Machine. The purpose of the prime mover is to overcome the resistance and to provide power to run the required speed of the machine.
   3 Differences Between the Absolute and the Dependent Perpetual Motion Machines—there are only four minor differences between the two machines' structure and these are the Intake's Weight Compensator 9B and the Intake's Outbalancing Weight 9C and the Resistance Weight 6B and the Pull Weight 6C in the Absolute, which are not present in the Dependent. As a result, Absolute's structure is higher than the Dependent, and has a heavier Moving Component B and Counterweight Assembly 6.
D) C-M87 Operation Defined and Described
   1 Input Operation—the process where the Piston 1A draws water from the Storage/Supply Tank 8A which passes through the Intake Pipe 9A and finally stores it in the Cylinder/Storage Chamber 2A. In this process, the Gate Valve 2E opens while the Discharge Valve 3B closes. The Moving Component B and the End 5X travel in a downward direction while the End 5Y and the Counterweight Assembly 6 travel in an upward direction.
   2 Output Operation—the process where the Piston 1A discharges the water from the Cylinder/Storage Chamber 2A into the Output/Discharge Chamber 3A, Output Pipe 10A, and to the Turbine Pipe 7B. In this process, the Discharge Valve 3B opens while the Gate Valve 2E closes. The Moving Component B and the End 5X of the Lever 2 5A travel in an upward direction while the End 5Y of the Lever 2 5A and Counterweight Assembly 6 travel in a downward direction.
E) C-M87 Choice of Presentation
   1 Preference
      1-1 Absolute Perpetual Motion Machine—of the two types of perpetual motion machines, we prefer the Absolute Perpetual Motion Machine in our presentation.
      1-2 Output Operation—although we can use either the Output Operation or the Input Operation as the start of operation, we just simply choose the former. Take note that the Moving Component B and the End 5X of the Lever 2 5A are in the lowest point of travel position and the End 5Y of the Lever 2 5A and the Counterweight Assembly 6 are in the highest point of travel position. Please refer to FIG. 8.
F) C-M87 Housekeeping
   1. Calibration/Preparation
      1-1 Counterweight Momentum Spring 6D—although optional at the start of operation, this spring can be compressed so that it can be used to push (downward direction; that is from Point 5P to Point 5L of the Lever 2 5A) the Counterweight Assembly 6 as a whole to initially start the Output Operation.
      1-2 After the Counterweight Assembly 6 is counterbalanced by the weights of the water inside the Intake Pipe 9A, and the Intake's Weight Compensator 9B and after the area and the height of the Intake's Outbalancing Weight 9C has been calculated according to the desired speed (cycle per minute), C-M87 is ready for priming.
         Note: the weights of the Intake's Outbalancing Weight 9C and that of the Pull Weight 6C are more or less the same.
   2 Priming
      2-1 Water—C-M87 needs priming. Except the Turbine Pipe 7B, if preferred, the whole machine—that is from the Storage/Supply Tank 8A down to the Cylinder/Storage Chamber 2A and all the way to the tip of the Output Pipe 10A, must be filled with water before it can start operating. Once priming is done, C-M87 is ready for operation.
G) C-M87 Embodiments

With most, if not all of C-M87's significant coined terminologies have been defined and their functions described, I believe that with the aid of drawings the understanding on how C-M87 works is made even simpler and easier. Please note that the Start Position of Output/Discharge Process drawing FIG. 8 and the End Position of Input/Intake Process FIG. 13 are exactly the same. Likewise the End Position of the Output/Discharge Process FIG. 10 and the Start Position of the Input/Intake Process FIG. 11 are also exactly the same. Although there is a sort of drawing duplication, the objective is to show clearly a complete process that is from the start to the end on both the Input and Output Operations. There are also similarities between the drawings of the Output/Discharge Process FIG. 9 and the Input/Intake Process FIG. 12. However the difference between the two is their valves positioning.

Please note that only the following 4 parts have cutaways: 1) Cylinder/Storage Chamber 2A—to expose the Piston 1A; 2) Output/Discharge Chamber 3A—to expose the Discharge Valve 3B, Discharge Valve Spring 3C, G-Force Emulator Assembly 11, Output/Discharge Sliding Piston 3E; Output/Discharge Sliding Cylinder 3F; 3) Turbine Reservoir 7A—to expose the Output Pipe Feeder 10B; and 4) the Gate Chamber 2D—to expose the Gate Valve 2E, Gate Valve Spring 2F. These cutaway parts are significant to understanding the C-M87's operation. Please note further that the Non-moving Component A is represented by a bold line and the Moving Component B is represented by a thin line.
1 The Output Operation
   This operation is the pumping out of water from the Cylinder/Storage Chamber 2A all the way to the Output Pipe Feeder 10B and, finally, to the Turbine Reservoir 7A. Please refer to FIGS. 8, 9 and 10.
      1-1 FIG. 8 The Start Position of the Output/Discharge Process
         Valves—Discharge Valve 3B opens, Gate Valve 2E and G-Force Emulator Valve 11K close.
         Moving Component Momentum Spring 3D—is fully decompressed.
         Direction—The End 5Y, End 4Y, End 4W and the Counterweight Assembly 6 start traveling downward. The End 5X, End 4X, End 4T, Moving Component B, G-Force Emulator Assembly 11 and the water from the tip of the Piston 1A all the way to the tip of the Output Pipe 10A, start traveling upward. Water from the Storage/Supply Tank 8A all the way down to the Intake Pipe 9A is still.
         Counterweight Momentum Spring 6D—starts decompression.
      1-2 FIG. 9 The Output/Discharge Process
         Valves—Discharge Valve 3B opens fully; Gate Valve 2E and G-Force Emulator Valve 11K are closed.
         Moving Component Momentum Spring 3D—is now being compressed.
         Direction—The End 5Y, End 4Y, End 4W and Counterweight Assembly 6 are traveling downward. The End 5X, End 4X, End 4T, Moving Component B, G-Force Emulator Assembly 11 and the water from the tip of the Piston 1A all the way to tip of the Output Pipe 10A are traveling upward while concurrently the water is also being unloaded into the Turbine Reservoir 7A. Water from the Storage/Supply Tank 8A all the way down to the Intake Pipe 9A is inactive.
         Counterweight Momentum Spring 6D—is being decompressed.
      1-3 FIG. 10 The End Position of the Output/Discharge Process
         Valves—Discharge Valve 3B closes, Gate Valve 2E and G-Force Emulator Valve 11K remain closed.
         Moving Component Momentum Spring 3D—is fully compressed.
         Direction—The End 5Y, End 4Y, End 4W and the Counterweight Assembly 6 travel downward end. The End 5X, End 4X, End 4T, Moving Component B, G-Force Emulator Assembly 11 and water from the tip of the Piston 1A all the way to tip of the Output Pipe 10A traveling upward end. Water from the Storage/Supply Tank 8A all the way down to the tip of the Intake Pipe 9A remains inactive.
         Counterweight Momentum Spring 6D—is fully decompressed.
2 The Input Operation
   This operation is the supplying of water from Storage/Supply Tank 8A all the way down to the Cylinder/Storage Chamber 2. Please refer to FIGS. 11, 12 and 13.
      2-1 FIG. 11 The Start Position of the Input/Intake Process
         Valves—Gate Valve 2E and G-Force Emulator Valve 11K open; Discharge Valve 3B closes.
         Moving Component Momentum Spring 3D—starts decompression.
         Direction—The End 5Y, the End 4Y, the End 4W and the Counterweight Assembly 6 start traveling upward. The End 5X, the End 4X, the End 4T, Moving Component B and G-Force Emulator Assembly 11 start traveling downward. The water from the Output/Discharge Chamber 3A all the way to the tip of the Output Pipe 10A is still. Water from the Storage/Supply Tank 8A all the way down to the Intake Pipe 9A starts flowing downward to fill up the Cylinder/Storage Chamber 2A.
         Counterweight Momentum Spring 6D—is fully decompressed.
      2-2 FIG. 12 The Input/Intake Process
         Valves—Gate Valve 2E and G-Force Emulator Valve 11K open fully, Discharge Valve 3B is closed.
         Moving Component Momentum Spring 3D—is being decompressed.
         Direction—The End 5Y, End 4Y, End 4W and Counterweight Assembly 6 are now traveling upward. The End 5X, End 4X, End 4T, Moving Component B and G-Force Emulator Assembly 11 are traveling downward. The water from the Output/Discharge Chamber 3A all the way to tip of the Output Pipe 10A is inactive. Water from the Storage/Supply Tank 8A all the way down to the Intake Pipe 9A is now flowing downward filling up the Cylinder/Storage Chamber 2A.
         Counterweight Momentum Spring 6D—is now being compressed.
      2-3 FIG. 13 The End Position of the Input/Intake Process
         Valves—Gate Valve 2E and G-Force Emulator Valve 11K close; Discharge Valve 3B remains closed.
         Moving Component Momentum Spring 3D—is fully decompressed.
         Direction—The End 5Y, End 4Y, End 4W and Counterweight Assembly 6 travel ends. The End 5X, End 4X, End 4T, Moving Component B and G-Force Emulator Assembly 11 travel ends. Water from the Output/Discharge Chamber 3A all the way to the tip of the Output Pipe 10A remains inactive. Water from the Storage/Supply Tank 8A flowing all the way down to the Intake Pipe 9A ends. Cylinder/Storage Chamber 2A is full.
         Counterweight Momentum Spring 6D—is fully compressed.

What Can C-M87 Do?

The machine can produce energy output unimaginable by man. C-M87 is a very powerful synchronized multi-lever perpetual motion machine that can supply the world adequately with its infinite energy requirements. It can satisfactorily replace all kinds of conventional methods of energy extraction, satisfying the limitations of energy sources such as sun, wind, sea wave and rivers. Hence this perpetual motion machine can adequately produce the Global infinite requirement of man for energy, especially during this critical period.

1- Claims On Types Of Perpetual Motion Machine's Techniques And Workability Of C-M87
A The Absolute Perpetual Motion Machine
1 As Absolute Perpetual Motion Machine—during the Output Operations, it is employing the outweighing/outbalancing concept of which the Balancing Weight 6A, Resistance Weight 6B and Pull Weight 6C outweigh or outbalance the total weight of the Moving Component B; while during the Input Operation, the weight of the Moving Component B, Intake's Weight Compensator 9B and Intake's Outbalancing Weight 9C, outweigh or outbalance the total weight of the Counterweight Assembly 6; and furthermore, with the aforementioned outweighing/outbalancing concept during the Output and Input Operations, C-M87 runs without the need of a prime mover and as a more advisable option, it may use an Electric Motor 5G to maintain and control the speed of the machine's RPM but not as prime mover.
B The Dependent Perpetual Motion Machine
2 As Dependent Perpetual Motion Machine—it is totally adapting the principle of equilibrium or perfect balance approach where the weights of the Counterweight Assembly 6 (less Resistance Weight 6B and Pull Weight 6C) and the Moving Component B are perfectly equal and therefore it is not employing the outweighing/outbalancing concept, which are crucial components of the Absolute Perpetual Motion Machine and requires Electric Motor PM 5I to overcome the resistance and to maintain the prescribed RPM of C-M87.

2- Claims On Components, Parts, Techniques And Workability OF C-M87
C The Non-moving Component A
3 The Non-moving Component A has 5 Major Non-moving Parts that do not move in up and down motions namely: Machine/Water Weight Lever Assembly 5, Electric Generating Assembly 7, Storage/Supply Tank Assembly 8, Intake Assembly 9, Output Assembly 10, and although the Lever 2 5A and Crankshaft 5F move in up and down motions, the entire Machine/Water Weight Lever Assembly 5 and the Electric Motor RS 5G (and Electric Motor PM 5I, applicable only to Dependent Perpetual Motion Machine) do not move since they are fixed on their bases and are not subject to any counterweights.
D The Moving Component B
4 The Moving Component B has 6 Major Moving Parts that move in up and down motions dependent on End 5X travel during the Input and Output Operations namely: Piston Assembly 1, Cylinder/Storage Assembly 2, Output/Discharge Assembly 3, Water Weight Lever Assembly 4, G-Force Emulator Assembly 11, and furthermore, although not a machine part, water is included since it is a major part of the Moving Component B's total weight.
E The Counterweight Assembly Component C
5 The Counterweight Assembly Component is composed of only 1 Major Part—the Counterweight Assembly 6 and its main function is to equalize (applicable to Dependent Perpetual Motion Machine) the total weight of the Moving Component B and the water inside the system that is, from the tip of the Piston 1A all the way to the tip of the Output Pipe 10A by the weight of the Balancing Weight 6A and in the case of Absolute Perpetual Machine it provides the additional weight needed by Resistance Weight 6B to overcome the resistance and the weight needed by the Pull Weight 6C to perform the desired speed during the Output Operation.
F The Components Combination
6 The combination of Components and their functions and workability are the Techniques that resulted to the Invention of C-M87; that is, our claim in totality.

3- Claims on The Power of C-M87
G The Power Of C-M1
7 Since it works on the Techniques (the invention) and the underlying Principles of Equilibrium or perfect balance, pumping out 1 cubic meter of water per stroke through a 1.6-meter diameter 500-meter high pipe, with a total water weight of 1,000 tons or pumping out 70 cc of water per stroke through a 2.6 centimeter diameter, 32 meter high pipe, with a total water weight of 16.8 kilos, is practically the same easy job for C-M87.

4- Claims on Other Usage of C-M87 as Prime Mover Based on the Same Drawings and Specification
H Other Applications (Non Electric Power Generation)
8 It can be used to pump out water for water supply to urban and rural areas, irrigation, flood control, cooling system for centralized air conditioning and ice plant and other industrial applications, fire-fighting equipment; running elevators, cable cars, conveyors, and many more similar functions.
1 C-M87 Hydro and C-M87 Hydraulic
9 There are only two differences between the C-M87 Hydro and C-M87 Hydraulic as: 1) C-M87 Hydro uses water and relies heavily on heights for weights while C-M87 Hydraulic uses hydraulic fluid and weights or G-Force Emulator with U.S. patent application Ser. No. 12/288,988; 2) C-M87 Hydro does not have check valve since it is free flow, while C-M87 Hydraulic may have check valve which is closed during the Output Operation and opens immediately thereafter to release or discharge the hydraulic fluid into the turbine before the Input Operation takes place.
